(19) United States
(12) Patent Application Publication
(10) Pub. No.: US 2016/0246746 A1
(43) Pub. Date: Aug. 25, 2016

(54) SAS CONFIGURATION MANAGEMENT

(71) Applicant: HEWLETT PACKARD ENTERPRISE DEVELOPMENT LP, Houston, TX (US)

(72) Inventors: Chaowen Tan, Houston, TX (US); Shanna-Shaye Sashai Forbes, Houston, TX (US); Balaji Natrajan, Spring, TX (US)

(21) Appl. No.: 15/024,313

(22) PCT Filed: Sep. 24, 2013
(86) PCT No.: PCT/US13/61486

§ 371 Date: Mar. 23, 2016

(51) Int. Cl. G06F 13/38; G06F 9/445

(52) U.S. Cl. CPC G06F 13/385; G06F 9/44505

(57) ABSTRACT

Techniques to generate local configuration data of a connection of local end of a cable to a SAS expander, store the data to a memory of the expander, then send a request to a local module at the local end of the cable to store the data to a memory at the local end of the cable, and send a request to a SAS device connected to a remote end of the cable to store the data at a memory located at the remote end of the cable. In response to a disconnection and reconnection of the local end of the cable with the expander, send a request to the local module to retrieve the data. If the retrieved data is different than the stored data, then generate a signal to alert of a misconfiguration between the local end of the cable and the expander.

### BACKGROUND

Storage networks facilitate communication between storage resources and computer devices. In one example of a storage network, serial attached small computer system interface (SAS) provides a communications protocol for enabling communications between computer devices. According to the SAS protocol specification, SAS devices include initiators, targets, and expanders. Initiators may include devices that begin a SAS data transfer, while targets may be devices to which initiators transfer data. Expanders may include devices that facilitate data transfer between multiple initiators and multiple targets. The SAS protocol utilizes a point-to-point bus topology. Therefore, if initiators are required to connect to multiple targets, direct connections may be established between initiators and each individual target to facilitate each individual data transfer between the initiators and each individual target. Expanders may manage connections and data transfer between multiple initiators and multiple targets. A SAS fabric may include a network of initiators, targets and expanders.

### BRIEF DESCRIPTION OF THE DRAWINGS

Certain examples are described in the following detailed description and in reference to the drawings, in which:

FIG. 1 is an example block diagram of a system for SAS configuration management in accordance with the techniques of the present application;

FIG. 2 is an example process flow diagram of a method for SAS configuration management in accordance with the techniques of the present application;

FIG. 3 is another example process flow diagram of a method for SAS configuration management in accordance with the techniques of the present application; and

FIG. 4 is an example block diagram showing a non-transitory, computer-readable medium that stores instructions for SAS configuration management in accordance with the techniques of the present application.

### DETAILED DESCRIPTION

A SAS fabric may include a network of initiators, targets and expanders configured to communicate with each other over the fabric according to the SAS protocol specification. For instance, a SAS fabric may comprise initiators configured as devices such as hosts or server computers that may communicate with targets configured as devices such as storage subsystems. In some cases, expanders may receive from initiators requests to establish connections with targets to exchange data with the targets. In a SAS fabric or environment, expanders, initiators and targets may include logical communication ports comprised of PHYs which are physical communication devices or structures to provide connection and communication means for transmitting and receiving data through expanders and between initiators and targets. The devices of the fabric may be connected to each other using communication media such as cables that may include electrical or optical conductors to convey signals that represent data and commands transmitted by the devices through the cables. During the configuration of the network, a user such as a system administrator may connect or attach the cables to the ports of the devices to establish connections between the devices. In some cases, such as during repair or replacement of the devices, there may be a need to perform a process to disconnect and then reconnect the cables to the devices. However, during this process, a cable misconfiguration or miscabling may occur in which the cables may be reconnected to the wrong ports, such as ports different than the original ports, which may cause improper operation resulting in data loss in the system.

For example, misconfiguration of cables may be a cause of service outage, data loss, and other common problems in data centers. Maintenance tasks such as repair or replacement of devices or hardware components may involve direct interaction with the devices of the network and which may be dependent on the accuracy of a user or service technician. During this process, a common problem or mistake may occur, such as having the cable connected or plugged to the wrong port, such as a port different than the original port, which may potentially introduce unrecoverable problems such as data loss in the data center. Therefore, there may be a need to provide safety measures so data center administrators may be able to verify and detect unintentional device or hardware cabling issues prior to the occurrence of unrecoverable problems.

In one example of the present application, described are techniques to help detect misconfiguration of connection of cables to devices to help manage or reduce occurrence of data loss because of such misconfiguration. In one example, the system or network may include cables that are active with functionality including management modules or techniques and memory located on the cables to store data about the configuration of the cables connected to the devices of the system. The system may include devices such as expanders, initiators, targets, switches that include functionality such as management modules or techniques located at the devices that may include memory to store data about the current device hardware configuration. The data stored in memory on the cables and devices may include data or information about the connectivity between the devices such as connection between the initiators such as host and servers, expanders and switches, and targets such as storage systems. The configuration data about the device hardware of the system may be used during the operation of the system such as during the process of initialization and during the process of device repair or replacement.

For example, during the process of initialization or first time set up, the devices, such as initiators, expanders, targets, may be configured or connected as part of a network and in a physical arrangement such as in a rack system with includes enclosures and shelves to house such devices. A user, such as a system administrator, may verify the configuration using management techniques which include management software located at one of the devices such as a switch. Once the configuration is verified, the uniquely identifiable configuration data or information about the attached devices may be stored onto memory located on the cables. This configuration data or information may include for example, rack location data, expander or switch SAS address, switch or expander port number, storage enclosure logical identifier, storage enclosure port number, storage enclosure input/output (I/O) module location and the like.

In another example, during the process of device repair or replacement, a user such as a service technician, may disconnect or unplug cables from non-functional devices and remove them from the rack system. The service technician may then place the new functional replacement devices into the rack system and then reconnect or plug the cables back to the devices. The management techniques, such as management software located at the switch, may detect this device hardware change and then retrieve the saved configuration data on the cables that were reconnected. If the previous or original configuration data is consistent or the same as the current retrieved configuration data, then the management techniques may present the user with an alert such as an informational message about this hardware or device change and allow the devices to communicate over the network. On the other hand, if the configuration data is inconsistent or different than the current retrieved configuration data, then the management techniques may send an alert or warning to the user to allow for correction of the misconfiguration.

In one example, the misconfiguration may include an inconsistent state or configuration where the cable was reconnected or plugged into a different port or even a completely different type of device than the previous or original configuration. The management techniques then may wait for a confirmation from the user regarding the device or hardware change before allowing the new devices or hardware to communicate or interact with the rest of the network or system. In this manner, the management techniques may prevent the devices or hardware in a potentially misconfiguration or miscabled cable configuration from interacting with one another. In one example, the techniques may perform actions on the devices or cables to prevent them from communicating such as to disable the PHYs or the ports associated with the connection, remove power to the cable associated with the connection, remove zoning access to the device associated with the connection and the like.

As explained below in further detail, the techniques of the present application may detect misconfiguration of connection of cables to SAS devices and help manage or reduce data loss because of such misconfiguration. In one example, the techniques include a SAS expander with a configuration management module to manage a SAS configuration. The configuration management module, in response to a connection of local end of a cable to a port of the SAS expander, may generate local configuration data associated with the connection, store the local configuration data to a memory of the SAS expander, send a request to a local management module at the local end of the cable to store the local configuration data to a memory at the local end of the cable, and send a request to a SAS device connected to a remote end of the cable to cause a remote management module to store the local configuration data at a memory located at the remote end of the cable. The configuration management module, in response to a disconnection and then a reconnection of the local end of the cable with a port of the SAS expander, may send a request to the local management module to retrieve the local configuration data. The configuration management module, if the retrieved configuration data is different than the stored configuration data, may then generate a signal to alert of a misconfiguration between the local end of the cable and the port of the SAS expander.

In another example, techniques of the present application describe a configuration management module that, if the retrieved configuration data is different than the stored configuration data, may prevent communication between the SAS expander and the cable until receipt of a confirmation signal to proceed with communication between the SAS expander and the cable. The configuration management module, if the retrieved configuration data is the same as the stored configuration data, may allow communication between the SAS expander and the cable. The configuration management module is configured to receive a request from a SAS device connected to the remote end of the cable to cause the local management module to store remote configuration data at the memory located at the local end of the cable, and respond to the request with another request sent to the local management module to store the remote configuration data at the memory located at the local end of the cable. The local configuration data includes a port identifier of a port connected to cable and wherein a misconfiguration includes when the cable is reconnected to a port that is different than the port which the cable was connected to before the disconnection and reconnection.

In another example, the techniques include a cable for managing SAS configuration. The cable includes a local management module coupled to a local end of the cable for a local connection to a port of a SAS device, wherein the local management module, in response to a request from a SAS device for local configuration data associated with a connection between the port and the SAS device, may retrieve the local configuration data from a local memory and return it to the SAS device. The cable includes a remote management module coupled to a remote end of the cable for a remote connection to another port of another SAS device, wherein the remote management module, in response to a request from the other SAS device for remote configuration data associated with the connection between the other port and the other SAS device, may retrieve remote configuration data from a remote memory and return it to the other SAS device.

In this manner, these techniques may detect misconfiguration of connection of cables to SAS devices and help manage or reduce data loss because of such misconfiguration.

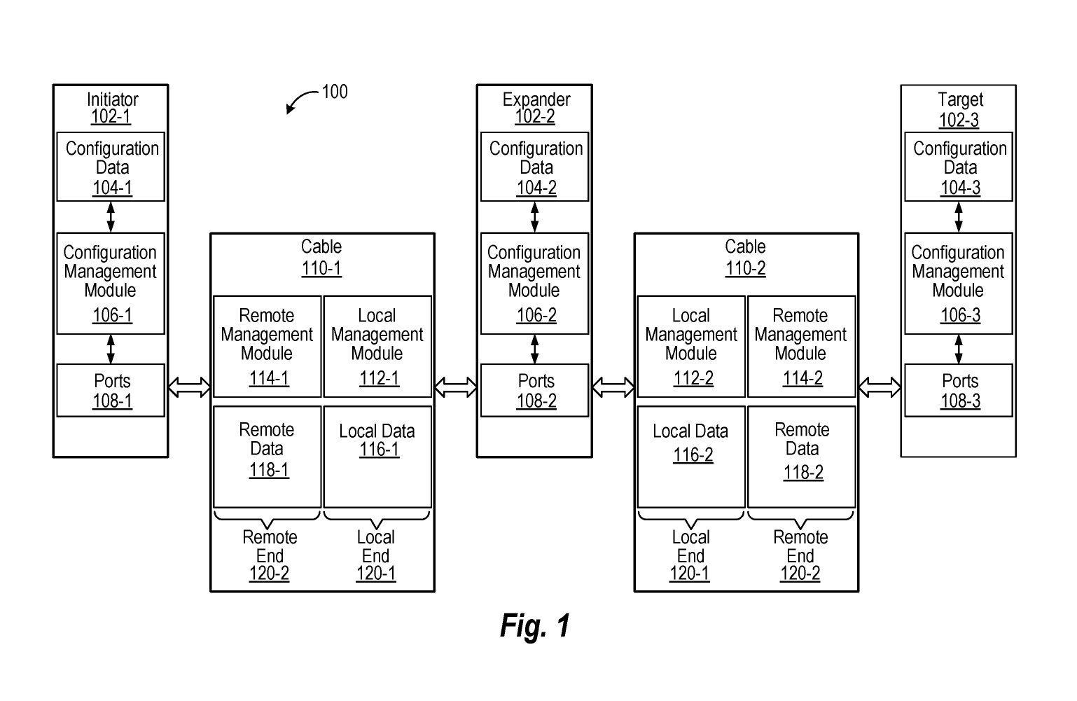

FIG. 1 is an example block diagram of a system 100 comprising devices 102 (102-1 through 102-3) coupled or connected to each other with cables 110 (110-1 through 110-2) as part of a network configured for configuration management in accordance with the techniques of the present application.

In one example, system 100 includes an expander 102-2 with ports 108-2 for connection to ports 108-1 of an initiator 102-1 and for connection to ports 108-3 of a target 102-3. The ports 108-2 of expander 102-2 may be configured to connect to a local end 120-1 of a first cable 110-1 and to a local end 120-1 of a second cable 110-2. In a similar manner, the ports 108-1 of initiator 102-1 may be configured to connect to a remote end 120-2 of first cable 110-1. Likewise, the ports 108-3 of target 102-3 may be configured to connect to a remote end 120-2 of second cable 110-2. As explained below in further detail, the system 100 including initiator 102-1, expander 102-2, target 102-3, first cable 110-1 and second cable 110-2 may be configured to implement configuration management techniques of the present application.

The functionality and operation of system 100 is described from the perspective of expander 102-2 such that local end 120-1 of first cable 110-1 and local end 120-1 of second cable 110-2 refer to the ends of the cable that are nearest to the ports of the expander and that remote ends 120-2 of the cables refer to the ends of the cable that are furthest from the ports of the expander. On the other hand, it should be understood that, from the perspective of initiator 102-1 and target 102-3, the local ends 120-1 of the cables refer to the ends of the cable that are furthest from the ports of the initiator and target and that remote ends 120-2 of the cables refer to the ends of the cable that are nearest to the ports of the initiator and the target. The system 100 may be configured to operate as a storage network such as a SAS fabric with the devices being SAS enabled to allow them to communicate with each other and over the SAS fabric in accordance with the SAS specification and protocols. However, it should be understood that system 100 may be configured in accordance with other network specifications and protocols such as Ethernet, Fibre Channel and the like.

The expander 102-2 includes configuration data 104-2, configuration management module 106-2 and ports 108-2 configured to implement configuration management techniques of the present application. In a similar manner, initiator 102-1 includes configuration data 104-1, configuration management module 106-1 and ports 108-1 configured to implement configuration management techniques of the present application. Likewise, target 102-3 includes configuration data 104-3, configuration management module 106-3 and ports 108-3 configured to implement configuration management techniques of the present application. As described below in further detail, the functionality and operation of expander 102-2 to implement the configuration management techniques of the present application is described from the perspective of the expander. However, it should be understood that initiator 102-1 and target 102-3 include similar functionality as expander 102-2 and may implement the techniques of the present application in a similar manner as the expander.

The configuration management module 106-2 may be configured to detect connection of cables 110 to expander 102-2. For example, configuration management module 106-2 may be configured to respond or detect connection of cables 110 to ports 108-2 of the expander and then generate local configuration data associated with the connection. For example, configuration management module 106-2 may respond or detect connection of local end 120-1 of second cable 110-2 to a port 108-2 of expander 102-2 and then generate local configuration data associated with that connection. For example, the local end connection may be detected by a presence pin located in the cable that would trigger an interrupt to the expander when the cable is plugged into the port. The remote end connection may be detected by the expander when one or more expander PHYs link up allowing a communication channel to the target via SAS. The configuration management module 106-2 may store the local configuration data to a memory of expander 102-2 such as in configuration data 104-2. The configuration management module 106-2 may send a request to local management module 112-2 at the local end 120-1 of the second cable 110-2 to store the local configuration data to a memory at the local end of the cable such as in local data 116-2. The configuration management module 106-2 may send a request to another device, such as target 102-3, connected to a remote end 120-2 of the second cable 110-2 to cause a remote management module 114-2 of the cable to store a copy of the local configuration data 116-2 at a memory located at the remote end of the second cable such as remote data 118-2. In this way, a copy of the local configuration data 116-2 is stored on the cable to provide redundancy of device or cable failure.

In another example, in a similar manner, configuration management module 106-2 may respond or detect connection of local end 120-1 of first cable 110-1 to a port 108-2 of expander 102-2 and then generate local configuration data 112-2 associated with the connection. The configuration management module 106-2 may store the local configuration data to a memory of expander 102-2 such as in configuration data 104-2. The configuration management module 106-2 may send a request to local management module 112-1 at the local end 120-1 of the first cable 110-1 to store the local configuration data to a memory at the local end of the cable such as in local data 116-1. The configuration management module 106-2 may send a request to another device, such as initiator 102-1, connected to a remote end 120-2 of the first cable 110-1 to cause a remote management module 114-1 of the cable to store the local configuration data 116-1 at a memory located at the remote end of the first cable such as remote data 118-1.

The configuration data 104-2 may include any information or data related to the configuration or connection of cables to the expander. For example, the configuration data 104-2 may include a port identifier of a port connected to the cable, rack location data associated with the connection, expander or switch SAS address associated with the connection, switch or expander port number associated with the connection, storage enclosure logical identifier associated with the connection, storage enclosure port number associated with the connection, storage enclosure input/output (I/O) module location associated with the connection and the like. In a similar manner, configuration data 104-1 of initiator 102-1 and configuration data 104-3 of target 102-3 may include any information or data related to the configuration or connection of cables to the respective devices. Likewise, local data 116 and remote data 118 stored at cables 110 may include any information or data related to the configuration or connection of cables to the respective devices. In this manner, replication of configuration data is achieved by having a copy of the configuration data stored or replicated at both ends to the cable to improve redundancy in case of failure of one of the devices or ends of the cable.

A connection may be defined as a state or event in which a cable is connected to a port of a device. A disconnection and then reconnection may be defined as a state or event in which a cable is detached or disconnected from a port of device and then reattached or reconnected to a port of a device. A misconfiguration may be defined as a state or event in which a cable is reattached or reconnected to a port that is different than the port which the cable was originally or initially connected to before the disconnection and reconnection occurred.

The configuration management module 106-2 may be configured to detect disconnection and then reconnection of cables to expander 102-2. For example, configuration management module 106-2 may respond to disconnection and reconnection of local end 120-1 of second cable 110-2 to a port 108-2 of expander 102-2. In another example, configuration management module 106-2 may respond to disconnection and reconnection of remote ends 120-2 of cables to ports 108-2 of expander 102-2. For example, disconnecting a cable at the local end may cause an interrupt to the expander via a cable presence pin that may be implemented in the cable. In another example, reconnection may be determined using the same technique. In one example, remote end disconnection and reconnection may be detected via PHY link status mechanism The configuration management module 106-2 may respond to the disconnection and reconnection by sending a request to the local management module 112-2 of the second cable 110-2 to retrieve the local data 116-2 at the local end 120-1 of the second cable. In a similar manner, configuration management module 106-2 may respond to disconnection and reconnection of local end 120-1 of first cable 110-1 to a port 108-2 of expander 102-2. In this case, configuration management module 106-2 may respond to the disconnection and reconnection by sending a request to the local management module 112-1 of the first cable 110-1 to retrieve the local data 116-1 at the local end 120-1 of the first cable.

The configuration management module 106-2 may be configured to detect a misconfiguration between a cable and expander 102-2. For example, configuration management module 106-2 may compare the retrieved configuration data from the second cable 110-2 with the stored configuration data from configuration data 104-2 stored at expander 102-2. If the retrieved configuration data is different than the stored configuration data, then configuration management module 106-2 may generate a signal to alert of a misconfiguration between the local end of the cable and the port of the expander. The management module 106-2 may wait for a confirmation or signal from the user before allowing the expander or port connected to the cable to communicate or interact with the rest of the network or system. The configuration management module 106-2 may prevent the expander with potentially misconfiguration or miscabled cable configuration from interacting with one another and the rest of the network. For example, management module 106-2 may perform actions on the expander or port connected to the cable to prevent them from communicating such as to disable the PHYs or the ports associated with the connection, remove power to the cable associated with the connection, remove zoning access to the devices associated with the connection and the like. On the other hand, if the retrieved configuration data is the same as the stored configuration data, then management module 106-2 may send a signal to the user of the proper reconnection and allow communication between the expander or the port and the cable and the rest of the of the network.

The above was described in relation to expander 102-2 being configured to manage cable configuration or connections such as detection of connections, disconnections and reconnections and misconfiguration of cables to ports of the expander. However, it should be understood that initiator 102-1 and target 102-3 may be configured to manage cable connections such as detection of connections, disconnections and reconnections and misconfiguration of cables in a similar manner as expander 102-2.

As explained above, system 100 may be configured as a fabric with devices connected to each other using communication media such as cables 110. For example, second cable 110-2 includes a local end 120-1 for connection to a port of one device and a remote end 120-2 for connection to another device. The local end 120-1 includes a local management module 112-2 and a local data 116-2. In a similar manner, the remote end 120-2 includes a remote management module 114-2 and a remote data 118-2. The local management module 112-2 is configured to receive from a device, such as expander 102-2, requests to store configuration data associated with the connection of a port to local end of the cable and respond by storing the data into local data 116-2 which is associated with memory of the cable. The local management module 112-2 is configured to check for receipt of a request from a device, such as expander 102-2, for local configuration data. In response to the request, local management module 112-2 retrieves the local configuration data from local memory and returns it to the device. In a similar manner, remote management module 114-2 is configured to receive requests from a management module coupled to a remote end of the cable for a remote connection to another port of another device such as target 102-3. In response to the requests from the target for remote configuration data, remote management module 114-2 retrieves remote configuration data from remote memory and returns it to the target 102-3.

The cables 110 may include any communication media to convey signals between devices. For example, cables 110 may include electrical conductors to convey electrical signals that represent data and commands transmitted by the devices through the cables. In another example, cables 110 may include optical conductors to convey signals using optical signals. The cables 110 may receive power from the devices to power components of the cables such as management modules associated with the cables. The cables 110 and devices may include any physical connection mechanisms to allow the cables to detachably connect to the devices. In one example, the cables 110 may be configured to connect to ports and may support multiple communication channels such as multiple PHYs as part of a SAS configuration. The connection or attachment mechanisms may include plugs, jacks, sockets and the like.

The devices 102 may communicate with cables 110 using any communication mechanisms such as wired and wireless techniques such as inter-integrated circuit 120 and the like. In one example, the expander may communicate with the memory of the cable using 120 bus techniques which provide a 2-wire interface. In this arrangement, the expander may be configured as the master device and the memory of the cable may be configured as the slave device. The command set for this arrangement may be defined by vendors or by standard commands such as read and write commands to access the different bytes of the memory of the cable. In another example, the expander and other devices may employ in-band SAS communication using the PHYs that are connected or attached to the devices such as initiators, expanders and targets. In one example, the commands to communicate between devices may include specific SCSI commands such as READ VENDOR SPECIFIC BUFFER and WRITE VENDOR SPECIFIC BUFFER to access the remote end of the cable using the attached devices such as expanders, initiators, targets as a proxy.

The above was described in the context of second cable 110-2 but it should be understood that the techniques may be applied to the first cable 110-1 that may be connected between expander 102-2 and initiator 102-1. In another example, the local management modules 112 and remote management modules 114 of the cables may be further configured to receive requests from devices to disable the at least one of the local management module and remote management module to prevent communication through the cable. In another example, the local data 116 and remote data 118 data stored in memory of the cables 110 which may include non-volatile memory to maintain and be able to later retrieve the data from the memory of the cable after disconnection of the cable from the devices.

The cables 110 are described as having local management modules and remote management modules along with respective local and remote data. However, it should be understood that the cables may be configured to have other arrangements to implement the techniques of the present application. For examples, the cables 110 may be configured to have a single management module and data to manage both local and remote functionality.

The system 100 was described in the context of an expander 102-2 providing a central management means for configuration management of the overall fabric. However, it should be understood that other configurations are possible to implement the techniques of the present application. For example, system 100 may include a switch that includes or supports at least one expander. The switch may include configuration management module functionality and provide centralized management of the cable configuration as well as control or manage zoning of the fabric. The term zoning in the fabric refers to techniques to control or manage permission or access to devices of the fabric. For example, the switch may include information to allow a first device to access a second device but prevent the first device from access to a third device. The switch may be configured to include functionality of configuration management module 106-2 including functionality to store or program the memory of the cables with configuration data related to the connection of the cable to the switch and other devices of the fabric. In another example, the switch may include multiple expanders and the switch may be connected to other switches with multiple expanders in a cascade or daisy chain manner.

The system 100 is shown as configured in a SAS fabric with an initiator, expander and target. However, it should be understood that other fabric or network topologies are possible to implement the techniques of the present application. For example, system 100 may include storage enclosures or just a bunch of drives (JBODs) technology as part of the fabric. In one example, the storage enclosure may include multiple expanders configured to host multiple storage systems such as disk drives. The storage enclosure may include a management module to manage location or configuration data regarding devices connected or attached to the ends of the cables. The configuration data may include port numbers or PHYs associated with the connection of the cables to devices and the like. In addition, the configuration data may include location data or information or identification regarding the storage enclosure itself.

The storage enclosure may be configured as a single or dual domain arrangement or configuration. For example, in a dual domain configuration, the storage enclosure may include two I/O modules with each of the modules having expanders to connect to an initiator with two separate cables. This dual domain configuration may allow initiators to have multiple paths to the same disk drive as part of a single storage enclosure. In this case, if one I/O module fails, then the other functional I/O module may continue to access the disk drives thereby avoiding a single point of failure. The storage enclosure may be assigned a unique SAS address, sometimes referred to as a storage enclosure logical identifier. The expanders may also be assigned unique SAS addresses. In one example, the system 100 may include a single initiator connected to a single storage enclosure having two I/O modules. The initiator may discover two expanders but may need to determine whether the two expanders are part of the same enclosure. In this case, the initiator requests or inquires the storage enclosure to provide the storage enclosure logical identifier of the storage enclosure. In one example, the storage enclosure logical identifier may be the same values as the first expander and the second expander which means that the expanders are part of the same storage enclosure. The storage enclosure may use this identification data to identify the devices connected to the cables and store this data in the cables for configuration management techniques as described herein. In other examples, the configuration data stored on the cables 110 may include port numbers of the ports connected to the cable, the address of the expanders connected to the cables, the PHY numbers of the ports connected to the cables and the like.

The initiator 102-1 may include or be configured to operate as a data processing device capable of generating requests for establishing connections for communications including exchanging data with other devices over the network or fabric of system 100. The initiator 102-1 may be capable of generating multiple connection requests sent to expander 102-2 and directed to storage resources associated with multiple targets 102-3. The Initiator 102-1 may comprise a host or server computer with an array controller to enable access and communicate with other devices on the fabric of system 100. The array controller may comprise a storage controller such as disk array controllers which may manage physical disk drives and may present them to the servers as logical units. In some examples, the array controller may implement redundant array of independent disks (RAID) functionality and may be referred to as RAID controllers.

The target 102-3 may include or be configured to operate as a data processing device capable of communication with expander 102-2 and manage storage resources with functionality for storage of data and for subsequent retrieval by initiator 102-1 or other devices. For example, target 102-3 may include storage resources as storage drives, such as disk drives, solid state drives, and the like.

The expander 102-2 may include route management functionality to manage the operation of expander communication with initiator 102-1 and target 102-3 as well as other expanders, initiators and targets of the network or fabric of system 100. The route management functionality may be configured to manage ports 108-2 to provide hardware and software interfaces for establishing connections for communication with initiator 102-1 and target 102-3 and other devices. The ports 108-2 which may include one or more PHYs that may comprise SAS protocol structures with transceivers for exchanging data and requests or commands between the expander and initiators and targets and other expanders.

The route management functionality may be configured to perform a discovery process of system 100 sometimes referred to as a self-configuration process of as part of a SAS environment or fabric. For example, upon boot up or power up of expander 102-2 or a change in the topology such as an addition, change or deletion of devices connected to the topology, route management functionality may proceed to discover or check for devices connected attached to the expander as part of the SAS topology or SAS fabric. The route management functionality may send discover commands, such as SAS discover commands, to devices and wait for responses from devices attached to expander, such as target devices, initiator devices as well as other expanders, to discover whether such devices are attached to expander. In one example, the management functionality may perform the discovery process and discover whether one or more initiators, targets or other expanders are directly or indirectly connected to the ports or PHYs of the expander.

In another example, route management functionality may be configured to perform the discovery process by further checking for devices attached to expander 102-2, such as other expanders, until the process determines that it has reached end devices such as initiator 102-1 or target 102-3. The route management functionality may determine or discover the destination addresses of destination devices such as targets connected to expander 102-2. The route management functionality may use the destination addresses to establish connections for communication to route data in response to connection requests through from initiators and through expander and to targets. The route management functionality may store the destination addresses of targets associated PHYs into a route table for subsequent use in routing data through expander and between initiators and targets.

The route management functionality is configured to respond to requests from initiators to store data to targets and retrieve data from targets. For example, to illustrate, it may be assumed that initiator desires to communicate with target. In this case, the initiator proceeds to send expander 102-2 a request or command to establish or open a connection for communication to route data through expander and between the initiator and target. In one example, the request may include a command to exchange data between the initiator and the target. The route management functionality may respond by examining route information to determine the PHY associated with the connection and corresponding destination address to route data between the PHY associated with initiator and the PHY associated with target. In one example, expander 102-2 may receive a request from the initiator to receive data from the initiator and to route the received data through an expander 102-2 and to store the data to the target. The route management functionality may also be configured to respond to requests from the initiator to retrieve data from the target and to route the retrieved data through the expander and to return the retrieved data back to the initiator.

The system 100 of FIG. 1 shows one example of a storage network configured as a SAS fabric with an expander 102-2 for establishing connections and routing data through the expander and between destination devices including initiator 102-1 and target 102-3. However, it should be understood that this configuration is for illustrative purposes and that a different number and arrangement of devices may be employed to implement the techniques of the present application. For example, system 100 may include a plurality of expanders 102-1 to establish connections between a plurality of initiators 102-1 and targets 102-3 to form multiple path topologies. The system 100 is described in relation to a storage network such as SAS fabric comprising expander 102-2 configured to communicate with initiator 102-1 and target 102-3 which are capable of implementing the SAS protocol specification. However, the techniques of the present application may employ other protocols such as Fibre Channel, Ethernet and the like. The functionality of the components of system 100, such as configuration management module 106-2, may be implemented in hardware, software or a combination thereof.

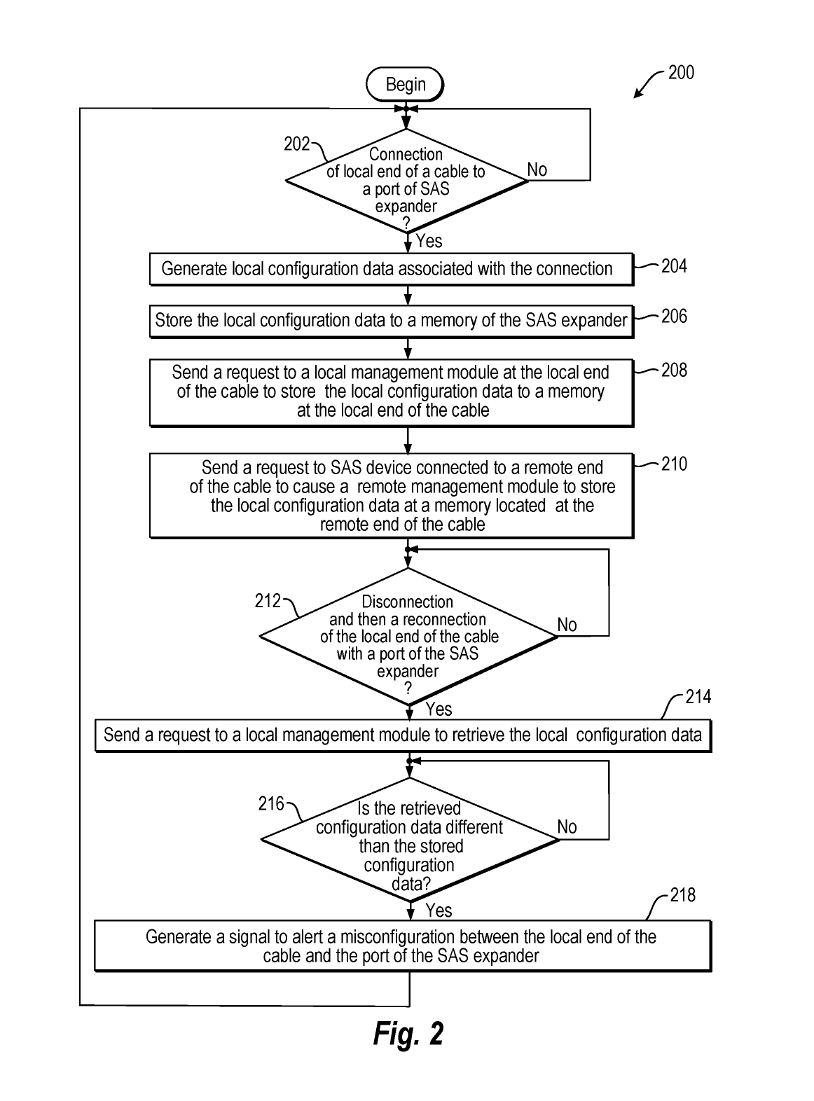

FIG. 2 is an example process flow diagram of a method 200 for SAS configuration management in accordance with the techniques of the present application.

To illustrate operation, the method 200 is described in relation to system 100 of FIG. 1. It may be assumed that system 100 is configured to include expander 102-2 with a first port of the plurality of ports 108-2 to be connected to initiator 102-1 through first cable 110-1 and a second port of the plurality of ports 108-2 of expander 102-2 to be connected to target 102-3 through second cable 110-2. It may be further assumed that system 100 may be configured as a SAS fabric or network environment with devices 102 (initiator 102-1, expander 102-2, target 102-3) and cables 110 (cable 110-1 and cable 110-2) configured as SAS enabled devices that may operate with each other over SAS fabric according to SAS protocols and specification. However, it should be understood that system of 100 may employ the techniques of the present application with other network or protocols such as Fibre Channel, Ethernet and the like.

The method may begin at block 202, where expander 102-2 checks whether there is a connection between a local end of a cable and a port of expander 102-2. For example, to illustrate, it may be assumed that a second port of the plurality of ports 108-2 of expander 102-2 is connected to a local end 120-1 of second cable 110-2. In this case, configuration management module 106-2 detects the connection of local end 120-1 of second cable 110-2 to the second port 108-2 and then processing proceeds to block 204. On the other hand, in another example, to illustrate, if there is no change in connection to the second port 108-2 of expander 102-2, then processing proceeds back to block 202 where expander 102-2 continues to check for a connection of cables 110 to ports 108-2 of the expander 102-2.

At block 204, expander 102-2 generates local configuration data associated with the connection. In one example, it may be assumed that configuration management module 106-2 detects the connection of local end 120-1 of second cable 110-2 to the second port 108-2 of expander 102-2. In this case, configuration management module 106-2 generates local configuration data associated with this connection. As explained above, the configuration data may include, for example, a port identifier of the port connected to cable, and in this case, the port identifier is associated with the second port of ports 108-2 connected to the local end 120-1 of second cable 110-2. Once expander 102-2 generates local configuration data associated with the connection, then processing proceeds to block 206.

At block 206, expander 102-2 stores the local configuration data to a memory of the expander. In this example, as explained above, configuration management module 106-2 generates local configuration data associated with the connection of local end 120-1 of second cable 110-2 to the second port of ports 108-2 of expander 102-2. The configuration management module 106-2 may then store this configuration data into memory of the expander such as configuration data 104-2 of expander 102-2. Once expander 102-2 stores the local configuration data to a memory of the expander, in this case configuration data 104-2, processing proceeds to block 208.

At block 208, expander 102-2 sends a request to a local management module at the local end of the cable to store the local configuration data to a memory at the local end of the cable. Continuing with the above example, configuration management module 106-2 generates local configuration data associated with the connection of local end 120-1 of second cable 110-2 to the second port of ports 108-2 of expander 102-2. In this case, configuration management module 106-2 may then send a request to local management module 112-2 at the local end 120-1 of the second cable 110-2 to store the local configuration data to a memory at the local end of the cable such as local data 116-2. Once expander 102-2 sends a request to local management module 112-2 at the local end of the cable to store the local configuration data at the cable, then processing proceeds to block 210.

At block 210, expander 102-2 sends a request to a device connected to a remote end of the cable to cause a remote management module to store the local configuration data at a memory located at the remote end of the cable. As explained above, to illustrate, in one example, it is assumed that local end 120-1 of second cable 110-2 is connected to second port 108-2 of expander 102-2. It may be further assumed that remote end 120-2 of second cable 110-2 is connected to a first port 108-3 of target 102-3. Continuing with the above example, configuration management module 106-2 of expander 102-2 sends a request to target 102-3 to cause configuration management module 106-3 of the target to store the local configuration data to a memory located at the remote end 120-2 of second cable 110-2, in this case, remote data 118-2 of the second cable. In this case, as explained above, the local configuration data may include the data associated with the connection of local end 120-1 of second cable 110-2 to the second port of ports 108-2 of expander 102-2. Once expander 102-2 sends the request to target 102-3 that is connected to a remote end 120-2 of the second cable 110-2, then processing proceeds to block 212.

At block 212, expander 102-2 checks for a disconnection and then a reconnection of the local end of the cable with a port of the expander. As explained above, it is assumed that local end 120-1 of second cable 110-2 is connected to the second port 108-2 of expander 102-2. To illustrate operation, in one example, it may be further assumed that that local end 120-1 of second cable 110-2 is disconnected and then reconnected to first port 108-2 of expander 102-2. The configuration management module 106-2 determines a disconnection and then a reconnection of the local end 120-1 of the second cable 110-2 with a port 108-2 of expander 102-2, and then processing proceeds to block 214. On the other hand, if there is no occurrence of a disconnection and reconnection of the local end 120-1 of the second cable 110-2, then processing proceeds back to block 212 where expander continues to check for the occurrence of such disconnection and reconnection.

At block 214, expander 102-2 sends a request to a local management module to retrieve the local configuration data. As explained above, it may be assumed that local end 120-1 of second cable 110-2 is disconnected and then reconnected to the second port 108-2 of expander 102-2. In this case, configuration management module 106-2 of expander 102-2 sends a request to local management module 112-2 of second cable 110-2 to retrieve local configuration data 116-2. In particular, local configuration data 116-2 includes the local configuration data associated with the connection of local end 120-1 of second cable 110-2 to the second port of ports 108-2 of expander 102-2. Once expander 102-2 sends a request to local management module to retrieve the local configuration data, then processing proceeds to block 216.

At block 216, expander 102-2 checks whether the retrieved configuration data is different than the stored configuration data. Continuing with the above example, configuration management module 106-2 compares the retrieved configuration data with the stored configuration data associated with the connection of local end 120-1 of second cable 110-2 to the second port of ports 108-2 of expander 102-2. If configuration management module 106-2 determines that the retrieved configuration data is different than the stored configuration data, then processing proceeds to block 218. For example, in one example, the local end of the second cable may have been disconnected from the second port of expander 102-2 and then reconnected to another port such as a third port of the expander. In this case, expander 102-2 detects a difference between the stored configuration data on expander and the retrieved configuration data from the second cable. In other words, if the cable is connected to a different port than was originally connected to, then there is a possible misconfiguration situation which the expander is to handle.

On the other hand, if expander 102-2 determines that the retrieved configuration data is the same as the stored configuration data, then processing proceeds to back block 216 to continue to check for differences. For example, in one example, the local end of the second cable may have been disconnected from the second port of expander 102-2 and then reconnected to the same port of the expander. In this case, expander 102-2 does not detect a difference between the stored configuration data on expander and the retrieved configuration data from the second cable. The expander would then continue to check for differences between the stored data and the retrieved data at block 216. In other words, if the cable is connected to the same port that was originally connected to, then there is no misconfiguration situation for the expander to handle.

At block 218, expander 102-2 generates a signal to alert of a misconfiguration between the local end of the cable and the port of the expander. For example, in one example, it may be assumed that local end of 120-1 of the second cable 110-2 was disconnected from the second port 108-2 of expander 102-2 and then reconnected to another port such as third port of the expander. In this case, configuration management module 106-2 detects the difference between the retrieved configuration data from the cable and the stored configuration data from the expander, and then generates a signal to alert of a misconfiguration between the local end of the cable and the port of the expander. In another example, configuration management module 106-2 may take further action such as to prevent communication between expander 102-2 and the cable until receipt of a confirmation signal to proceed with communication between the expander and the cable. A user of the system may attempt to address the misconfiguration situation by disconnecting the cable from the third port and reconnecting the cable to the first port. In one example, once the misconfiguration situation is resolved, processing may proceed back to block 202 to continue to check for connection of cables to the expander.

In this manner, in some examples, these techniques may help alert the user to a misconfiguration of the system so to help reduce potential data loss in the system. The above techniques illustrate one example of the techniques of the present application and it should be understood that other examples are possible to implement the techniques of the present application. For example, the above was described in the context of expander 102-2 but it should be understood that the techniques may be applied to the other devices such as initiator 102-1 and target 102-3.

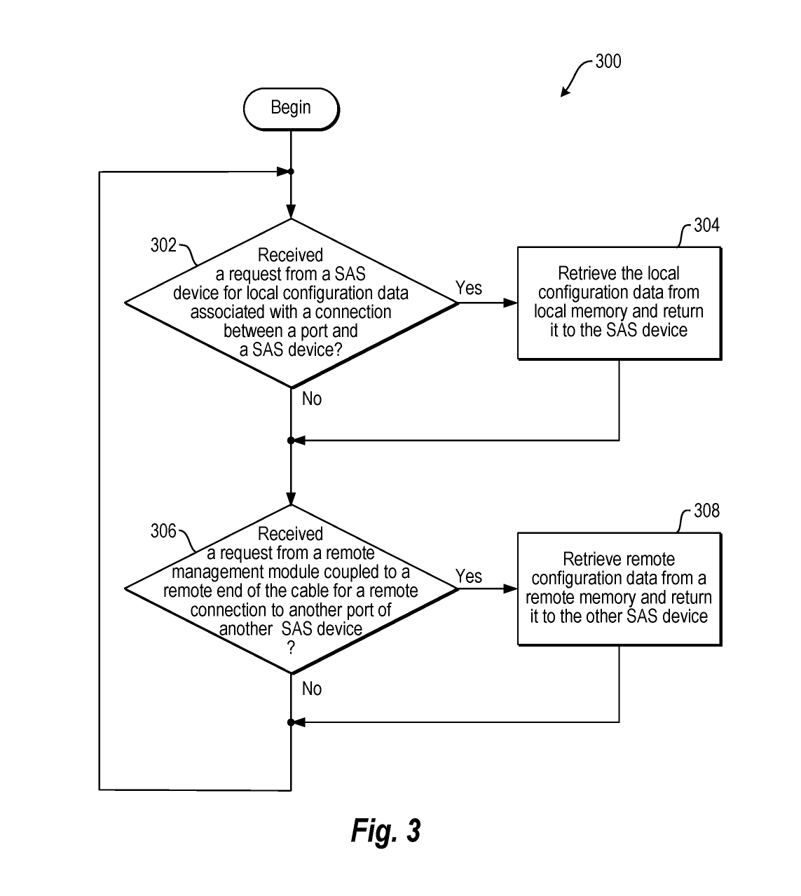

FIG. 3 is another example process flow diagram of a method 300 for SAS configuration management in accordance with the techniques of the present application.

To illustrate operation, the method 300 is described in relation to system 100 of FIG. 1. It may be assumed that system 100 is configured to include a first cable 110-1 connected between initiator 102-1 and expander 102-2 and a second cable 110-2 connected between expander 102-2 and target 102-3. It may be assumed that system 100 is configured as a SAS fabric or network environment with devices 102 (initiator 102-1, expander 102-2, target 102-3) and cables 110 (cable 110-1 and cable 110-2) configured as SAS enabled devices that may operate according to SAS protocols and specification. However, it should be understood that system of 100 may employ the techniques of the present application with other protocols such as Fibre Channel, Ethernet and the like.

In one example, to illustrate operation, it may assumed that a local end 120-1 of second cable 110-2 is connected to a first port of ports 108-2 of expander 102-2 and that a remote end 120-2 of second cable is connected to a first of ports 108-3 of target 102-3. It may also be assumed that expander 102-2 generates local configuration data associated with the connection of local end 120-1 of second cable 110-2. The expander 102-2 stores this configuration data into configuration data 104-2 of expander 102-2 which is associated with memory of the expander. Furthermore, the expander 102-2 sends a request to local management module 112-2 of second cable 110-2 to store this configuration data into local data 116-2 of the second cable 102-2 which is associated with memory of the second cable. In a similar, manner it may also be assumed that target 102-3 generates local configuration data associated with the connection of remote end 120-2 of second cable 110-2. The target 102-3 stores this configuration data into configuration data 104-3 of target 102-3 which is associated with memory of the target. Furthermore, the target 102-3 sends a request to remote management module 114-2 of second cable 110-2 to store this configuration data into remote data 118-2 of the second cable 102-2 which is associated with memory of the second cable.

The method may begin at block 302, where second cable 110-2 checks whether it has received a request from a SAS device for local configuration data associated with a connection between a port and a SAS device. Continuing with the above example, it may be assumed that expander 102-2 sends a request to local management module 112-2 of the second cable 110-2 to retrieve local configuration data 116-2 associated with the connection between local end 120-1 of second cable and the first port of expander 102-2. In response to the request from expander for local configuration data, processing proceeds to block 304. In other words, the expander may have detected a disconnection and then a reconnection of the cable to the expander and requires the configuration data stored at the cable to make a determination of misconfiguration. On the other hand, if second cable 110-2 does not receive a request from expander 102-2 for local configuration data, then processing proceeds to block 306 to continue to check for a request for remote data.

At block 304, second cable 110-2 retrieves the local configuration data from local memory and returns it to the SAS device. Continuing with the above example, local management module 112-2 of second cable 110-2 retrieves local data 116-2 associated with the connection between local end 120-1 of second cable and the first port of expander 102-2. The local management module 112-2 then sends to expander 102-2 the local data 116-2. Once the cable 110-2 retrieves the local configuration data from local memory and returns it to expander 102-2, processing proceeds to block 306. As explained above, expander 102-2 may use the retrieved data to detect whether a misconfiguration occurred between the second cable 11-2 and the expander.

At block 306, second cable 110-2 checks whether it has received a request from a remote management module coupled to a remote end of the cable for a remote connection to another port of another SAS device. Continuing with the above example, it may be assumed that target 102-3 sends a request to remote management module 114-2 of the second cable 110-2 to retrieve remote configuration data 118-2 associated with the connection between remote end 120-2 of second cable and the first port of target 102-3. In response to the request from the target for remote configuration data, processing proceeds to block 308. On the other hand, if second cable 110-2 does not receive a request from target 102-3 for remote configuration data, then processing proceeds back to block 302 to continue to wait for a request for local data.

At block 308, second cable 110-2 retrieves remote configuration data from remote memory and returns it to the other SAS device. Continuing with the above example, remote management module 114-2 of second cable 110-2 retrieves remote data 118-2 associated with the connection between remote end 120-2 of second cable 110-2 and the first port of target 102-3. The remote management module 114-2 then sends to target 102-3 the remote data 118-2. As explained above, target 102-3 may use the retrieved data to detect whether a misconfiguration occurred between the second cable 110-2 and the target 102-3. Once the second cable 110-2 retrieves remote configuration data and returns it to the target 102-3, processing proceeds back to block 302 to continue to check for requests for data.

In this manner, in some examples, these techniques may store configuration data in the cables which the expanders may use to help to detect misconfiguration of connection of cables to SAS devices and help manage or reduce data loss because of such misconfiguration. The above techniques illustrate one example of the techniques of the present application and it should be understood that other examples are possible to implement the techniques of the present application. For example, the above was described in the context of second cable 110-2 but it should be understood that the techniques may be applied to the first cable 110-1 connected between expander 102-2 and initiator 102-1. In another example, in response to misconfiguration situation, the local management module and remote management modules of the cable may be further configured to receive a request from devices to disable the at least one of the local management module and remote management module to prevent communication through the cable. In another example, the local memory and the remote memory of the cables may include non-volatile memory to maintain data and later retrieve the stored data after disconnection and reconnection of the cable from the devices.

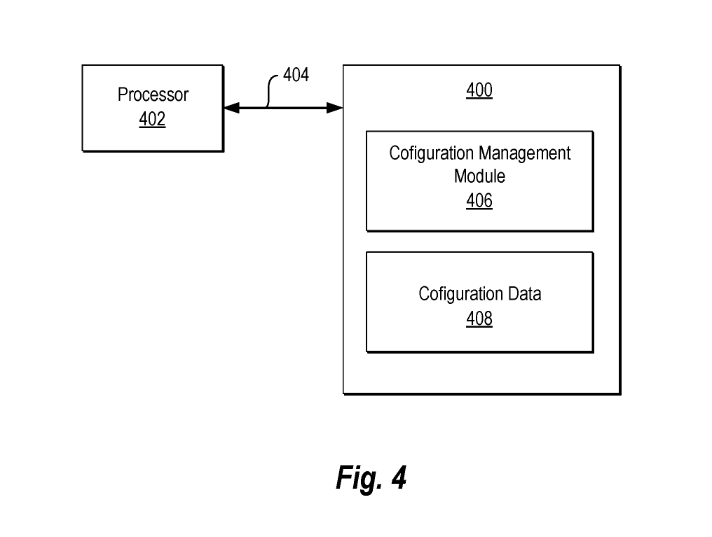

FIG. 4 is an example block diagram showing a non-transitory, computer-readable medium that stores instructions for SAS configuration management in accordance with the techniques of the present application. The non-transitory, computer-readable medium is generally referred to by the reference number 400 and may be included in SAS devices 102 and cables 110 of the SAS fabric described in relation to functionality of devices 102 and cables 110 as described herein. The non-transitory, computer-readable medium 400 may correspond to any typical storage device that stores computer-implemented instructions, such as programming code or the like. For example, the non-transitory, computer-readable medium 400 may include one or more of a non-volatile memory, a volatile memory, and/or one or more storage devices. Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disk drives, compact disc drives, digital versatile disc drives, optical drives, and flash memory devices.

A processor 402 generally retrieves and executes the instructions stored in the non-transitory, computer-readable medium 400 to operate the expander in accordance an example. In an example, the tangible, machine-readable medium 400 may be accessed by the processor 402 over a bus 404. A first region 406 of the non-transitory, computer-readable medium 400 may include configuration management module as well as local and remote management module functionality as described herein. A second region 408 of the non-transitory, computer-readable medium 400 may include configuration data or information as well as local and remote data or information as described herein.

Although shown as contiguous blocks, the software components may be stored in any order or configuration. For example, if the non-transitory, computer-readable medium 400 is a hard drive, the software components may be stored in non-contiguous, or even overlapping, sectors.

1. A serial attached small computer system interface (SAS) expander for managing SAS configuration, the SAS expander comprising:
a configuration management module to:
in response to a connection of local end of a cable to a port of the SAS expander, generate local configuration data associated with the connection, and store the local configuration data to a memory of the SAS expander, and send a request to a local management module at the local end of the cable to store the local configuration data to a memory at the local end of the cable, and send a request to a SAS device connected to a remote end of the cable to cause a remote management module to store the local configuration data at a memory located at the remote end of the cable,
in response to a disconnection and then a reconnection of the local end of the cable with a port of the SAS expander, send a request to the local management module to retrieve the local configuration data, and
if the retrieved configuration data is different than the stored configuration data, then generate a signal to alert of a misconfiguration between the local end of the cable and the port of the SAS expander.

2. The SAS expander of claim 1, wherein, if the retrieved configuration data is different than the stored configuration data, then configuration management module is to prevent communication between the SAS expander and the cable until receipt of a confirmation signal to proceed with communication between the SAS expander and the cable.

3. The SAS expander of claim 1, wherein, if the retrieved configuration data is the same as the stored configuration data, then configuration management module is to allow communication between the SAS expander and the cable.

4. The SAS expander of claim 1, wherein the configuration management module further is configured to receive a request from a SAS device connected to the remote end of the cable to cause the local management module to store remote configuration data at the memory located at the local end of the cable, and respond to the request with another request sent to the local management module to store the remote configuration data at the memory located at the local end of the cable.

5. The SAS expander of claim 1, wherein the local configuration data includes a port identifier of a port connected to cable and wherein a misconfiguration includes when the cable is reconnected to a port that is different than the port which the cable was connected to before the disconnection and reconnection.

6. A method of managing serial attached small computer system interface (SAS) configuration, the method comprising:
in response to a connection of local end of a cable to a port of a SAS expander, generating local configuration data associated with the connection, and storing the local configuration data to a memory of the SAS expander, and sending a request to a local management module at the local end of the cable to store the local configuration data to a memory at the local end of the cable, and sending a request to a SAS device connected to a remote end of the cable to store the local configuration data at a memory located at the remote end of the cable; and
if there is a disconnection and then a reconnection of the local end of the cable with the port of the SAS expander, then checking if the configuration data from the local management module is different than the stored configuration data, and if they are different, then generating a signal to alert of a misconfiguration between the local end of the cable and the port of the SAS expander.

7. The method of claim 6, wherein, if the retrieved configuration data is different than the stored configuration data, then preventing communication between the SAS expander and the cable until receipt of a confirmation signal to proceed with communication between the SAS expander and the cable.

8. The method of claim 6, wherein, if the retrieved configuration data is the same as the stored configuration data, then allowing communication between the SAS expander and the cable.

9. The method of claim 6, further comprising receiving a request from a SAS device connected to the remote end of the cable to cause the local management module to store remote configuration data at the memory located at the local end of the cable, and responding to the request with another request sent to the local management module to store the remote configuration data at the memory located at the local end of the cable.

10. The method of claim 6, wherein the local configuration data includes a port identifier of a port connected to the cable, and wherein a misconfiguration includes when the cable is reconnected to a port that is different than the port which the cable was connected to before the disconnection and reconnection.

11. A cable for managing serial attached small computer system interface (SAS) configuration, the cable comprising:
a local management module coupled to a local end of the cable for a local connection to a port of a SAS device, wherein the local management module to, in response to a request from a SAS device for local configuration data associated with a connection between the port and the SAS device, retrieve the local configuration data from a local memory and return it to the SAS device; and
a remote management module coupled to a remote end of the cable for a remote connection to another port of another SAS device, wherein the remote management module to, in response to a request from the other SAS device for remote configuration data associated with the connection between the other port and the other SAS device, retrieve remote configuration data from a remote memory and return it to the other SAS device.

12. The cable of claim 11, wherein the local management module further configured to receive from the SAS device configuration data associated with the remote connection, and then store the local configuration data to a local memory of the SAS device.

13. The cable of claim 11, wherein the remote management module further configured to receive from the other SAS device configuration data associated with the local remote connection, and then store the remote configuration data to a remote memory of the SAS device.

14. The cable of claim 11, wherein at least one of the local management module and remote management module further configured to receive a request from a SAS device to disable the at least one of the local management module and remote management module to prevent communication through the cable.

15. The cable of claim 11, wherein at least one of the local memory and the remote memory comprises non-volatile memory to maintain data after disconnection of the cable from the SAS device.

16. The SAS expander of claim 1, wherein the configuration management module is to detect the connection by a presence pin in the cable that triggers an interrupt to the SAS expander when the cable is plugged into the port of the SAS expander.

17. The SAS expander of claim 16, wherein the configuration management module is to detect the disconnection by the presence pin in the cable that triggers an interrupt to the SAS expander when the cable is unplugged from the port of the SAS expander.

18. The SAS expander of claim 2, wherein the configuration management module is to prevent communication between the SAS expander and the cable by disabling ports associated with the connection, removing power to the cable associated with the connection, removing zoning access to the devices associated with the connection.

19. The method of claim 6, further comprising detecting the connection by a presence pin in the cable that triggers an interrupt to the SAS expander when the cable is plugged into the port of the SAS expander.

20. The method of claim 7, further comprising preventing communication between the SAS expander and the cable by disabling ports associated with the connection, removing power to the cable associated with the connection, and removing zoning access to the devices associated with the connection.
